(19) United States
(12) Patent Application Publication
(10) Pub. No.: US 2009/0066632 A1
(43) Pub. Date: Mar. 12, 2009

(54) PROCESSING DEVICE AND PROCESSING METHOD FOR HIGH DYNAMIC CONSTRAST OF LIQUID CRYSTAL DISPLAY DEVICE

(76) Inventor: Ming CHEN, Beijing (CN)

Correspondence Address: LADAS & PARRY LLP, 224 SOUTH MICHIGAN AVENUE, SUITE 1600, CHICAGO, IL, 60604, US

(21) Appl. No.: 12/126,050

(22) Filed: May 23, 2008

(30) Foreign Application Priority Data
Sep. 10, 2007 (CN) 200710121553.2

(51) Int. Cl. G09G 3/36

(52) U.S. Cl. 345/102; 345/87

(57) ABSTRACT

The present invention relates to a processing device and method for high dynamic contrast of a liquid crystal display device. The processing device comprises a receiver, an inverter and a source driving IC connected to a central processing module, a gamma voltage controller connecting to the source driving IC. The process method comprises: performing histogram statistic processing on a received low voltage differential signaling data; obtaining a backlight source dimming coefficient of picture of a same frame and an I/O gray scale mapping table corresponding to the backlight source dimming coefficient according to result of the histogram statistic processing; controlling to adjust data output to a source driving IC according to the I/O gray scale mapping table; and controlling luminance of a backlight source according to the backlight source dimming coefficient. The present invention adjusts the luminance of the backlight source and the output data of the LCD device concurrently, therefore improves dynamic contrast of pictures, mitigates problems of low contrast and flicker in the LCD, and save the power consumption of the backlight source.

### FIELD OF THE INVENTION

The present invention relates to a digital image processing device and processing method of a Liquid Crystal Display (LCD) device, and particularly to a processing device and processing method for high dynamic contrast of the LCD device.

### BACKGROUND OF THE INVENTION

For a Thin Film Transistor (TFT) liquid crystal panel, gamma curve is a curve that reflects a correspondence between the transmittance and gray scale of a pixel point on the TFT liquid crystal panel, and the curve directly reflects a basic display characteristic of the TFT liquid crystal panel. A gamma curve is shown in FIG. 1. FIG. 1 is a gamma curve of a liquid crystal panel in which the abscissa is the gray scale of the pixel point, the ordinate is the transmittance of the pixel point on the liquid crystal panel. When a gamma reference voltage of the LCD device is certain, the gamma curve is uniquely determined, that is, the relation between the transmittance and the gray scale of the pixel point is uniquely determined.

Luminance of the pixel point on the liquid crystal panel may be represented as:

L=B(β)×T(d) (1)

where L represents the luminance of a pixel point on the liquid crystal panel; B represents the luminance of a backlight source, which is a function of a backlight source dimming coefficient β; and T represents for the transmittance of this pixel point on the liquid crystal panel, which is a function of the gray scale d of the pixel point. A relation between the luminance L and the gray scale d of the pixel point may be obtained from the equation (1), which is referred to as L-D curve, as shown in FIG. 2. FIG. 2 is a graph of an L-D curve of the luminance and the gray scale of the pixel point on the liquid crystal panel.

With development of technique and reduction of cost, the TFT liquid crystal display and TFT liquid crystal television have been dominant in the art of display instead of the conventional CRT. As compared to the CRT displays, the TFT LCD devices have advantages of low radiation, low power consumption and small volume. However, one defect of the TFT LCD devices is in relatively lower luminance and contrast. Especially in displaying dark pictures, level sense is reduced due to the presence of the Gamma curve.

To address this problem, a Dynamic Gamma Control (DGC) solution is proposed in the prior art. The main design idea of DGC is to increase luminance differences between the gray scales which are dominant in a picture by varying the gamma voltage, so that the contrast of the picture is increased. In particular, firstly, a histogram statistics is performed on a Low Voltage Differential Signaling (LVDS) data received by a receiver, and then a gamma reference voltage processing is performed according to the result of the histogram statistics in which the dynamic ranges of gray scale voltages having more distribution is widened and the dynamic ranges of gray scale voltages having less distribution is narrowed, so that the contrast of the gray scales which are dominant in the picture is enhanced, thereby increasing the contrast of the picture. In practice, the DGC solution has the following technical problems:

(1) The luminance is increased with increment of the contrast, and the unnecessary luminance increases the power consumption of the backlight source and in turn the power consumption of the product; and

(2) Human eyes will perceive flicker in the pictures when continuous pictures shows alternation in brightness and darkness or a picture becomes brighter or darker sharply.

### SUMMARY OF THE INVENTION

One object of the present invention is to provide a processing device and processing method for high dynamic contrast of LCD device based on backlight source control, improving significantly the dynamic contrast and quality of a picture and overcoming efficiently the technical defects of high power consumption and flickering picture in the prior art, in the premise of constant luminance of the liquid crystal panel.

To achieve the above object, the present invention provides a processing device for high dynamic contrast of a liquid crystal display device comprising:

a receiver for receiving a low voltage differential signaling data and converting the low voltage differential signaling data into data in transistor-transistor logic format;

a central processing module connecting to the receiver for performing histogram statistic processing on the data in transistor-transistor logic format, obtaining a backlight source dimming coefficient of picture of a frame and an I/O gray scale mapping table corresponding to the dimming coefficient according to result of the statistic processing, generating a pulse-width modulation (PWM) dimming control signal from the backlight source dimming coefficient, obtaining an output data according to the I/O gray scale mapping table;

an inverter for receiving the PWM dimming control signal from the central processing module and driving the backlight source;

a gamma voltage controller for providing a gamma reference voltage for a source driving integrated circuit (IC); and

the source driving IC for receiving the output data and the gamma reference voltage from the central processing module and the gamma voltage controller, respectively, and driving a liquid crystal panel.

The central processing module comprises:

a statistic module for receiving data from the receiver and performing the histogram statistic processing on the data;

a query module for receiving result of the histogram statistic processing from the statistic module and obtaining the backlight source dimming coefficient of picture of a frame and the I/O gray scale mapping table corresponding to the dimming coefficient according to the result of the statistic processing;

a signal controller for receiving the backlight source dimming coefficient from the query module and generating the PWM control signal to be sent to the inverter;

a frame buffer for receiving the data in transistor-transistor logic format from the receiver and storing the data;

a data processing module for receiving the I/O gray scale mapping table and the data in transistor-transistor logic format from the query module and the frame buffer, respectively, and mapping the data in transistor-transistor logic format into the output data according to the I/O gray scale mapping table; and

a transmitter for reading the output data from the data processing module and transmitting the output data to the source driving IC.

The query module includes a storage unit storing a lookup table which records correspondence between the backlight source dimming coefficient and the I/O gray scale mapping table.

The data processing module includes:

a data receiving unit for receiving the data in transistor-transistor logic format input from the frame buffer and converting the data in transistor-transistor logic format into a gray scale;

a table receiving unit for receiving the I/O gray scale mapping table from the query module;

a data processing unit for mapping the gray scale input by the data receiving unit into an output gray scale according to the I/O gray scale mapping table input by the table receiving unit; and

a data output unit for converting the output gray scale received from the data processing unit into the output data in the transistor-transistor logic format and outputting the data.

To achieve the above object, the present invention further provides a processing method for high dynamic contrast of a liquid crystal display device, comprising:

performing histogram statistic processing on a received low voltage differential signaling data;

obtaining a backlight source dimming coefficient of picture of a same frame and an I/O gray scale mapping table corresponding to the backlight source dimming coefficient according to result of the histogram statistic processing;

controlling to adjust data output to a source driving integrated circuit (IC) according to the I/O gray scale mapping table; and

controlling luminance of a backlight source according to the backlight source dimming coefficient.

Said performing histogram statistic processing on a received low voltage differential signaling data comprises:

obtaining number of pixel points occupied by each gray scale on picture of a frame; and

determining the gray scales that have more distribution in picture of the frame according to a threshold value.

Said obtaining a backlight source dimming coefficient of picture of a same frame and an I/O gray scale mapping table corresponding to the backlight source dimming coefficient according to result of the histogram statistic processing comprises:

determining the backlight source dimming coefficient of picture of the same frame according to the result of the histogram statistic processing, and then calculating an I/O gray scale mapping relation corresponding to different dimming coefficients according to a relation between luminance of pixel points on a liquid crystal panel on one hand, and the gray scale and the dimming coefficient on the other hand; and

storing in a query module the I/O gray scale mapping relation in a form of the I/O gray scale mapping table.

Said controlling to adjust data output to a source driving IC according to the I/O gray scale mapping table comprises:

converting the received input data in the transistor-transistor logic format into an input gray scale;

mapping the input gray scale into an output gray scale according to the I/O gray scale mapping table;

converting the output gray scale into an output data in the transistor-transistor logic format and transmitting the output data to a transmitter; and

the transmitter reading the output data from a data processing module and sending the output data to the source driving IC.

Said controlling luminance of a backlight source according to the backlight source dimming coefficient comprises:

generating a pulse-width modulation (PWM) dimming control signal according to the backlight source dimming coefficient; and

using the PWM dimming control signal to drive the backlight source.

The processing device and processing method for high dynamic contrast of LCD device based on the backlight source control proposed in the present invention decreases the luminance of the backlight source to lower that of the picture while compensating the distortion due to the decrease in the luminance of the backlight source by adjusting the transmittance of the liquid crystal panel. The present invention adjusts concurrently the luminance of the backlight source and the output data of the liquid crystal panel, respectively, according to the result of the histogram statistic processing, therefore improves the dynamic contrast of pictures and mitigates the problems of relatively low contrast of the TFT LCD apparatus. This solution maintains the luminance of the liquid crystal panel unchanged after the luminance of the backlight source varies through the luminance query manner, thus mitigating the problems about flicker. Also, since the luminance of the backlight source is adjusted in a manner of the external PWM dimming, power consumption of the backlight source is saved. Especially in the case where the displayed picture is mostly in the dark state, the effect of the power saving will be very significant. The power consumption of the backlight source is over 40% of that in the entire LCD apparatus. Such solution for adjusting luminance of backlight source in the present invention saves the power consumption of the backlight source and reduces that of the final product. Further, the present invention improves main parameters of the products greatly so that the value of the TFT LCD apparatus is enhanced to a great extent.

Technical solutions of the present invention will be further described in conjunction with accompanying figures and embodiments.

### BRIEF DESCRIPTION OF THE DRAWINGS

FIG. 1 is a gamma curve of a liquid crystal panel.

FIG. 2 is a graph of an L-D curve of the luminance and the gray scale of a pixel point on the liquid crystal panel.

FIG. 3 is a structurally schematic diagram of a processing device for high dynamic contrast of LCD of the invention.

FIG. 4 is a structurally schematic diagram of an embodiment of the invention.

FIG. 5 is a structurally schematic diagram of a data processing module of an embodiment of the present invention.

FIG. 6 is a flow chart of a processing method for high dynamic contrast of LCD device of an embodiment of the invention.

### DESCRIPTION FOR REFERENCE NUMBERS ARE

10—receiver; 20—frame buffer; 30—statistic module; 40—query module; 50—signal controller; 60—inverter; 70—transmitter; 80—gamma voltage controller; 90—source driving integrated circuit; 100—data processing module; 11—data receiving unit; 12—table receiving unit; 13—data processing unit; 14—data output unit.

### DETAILED DESCRIPTION OF THE PREFERRED EMBODIMENTS

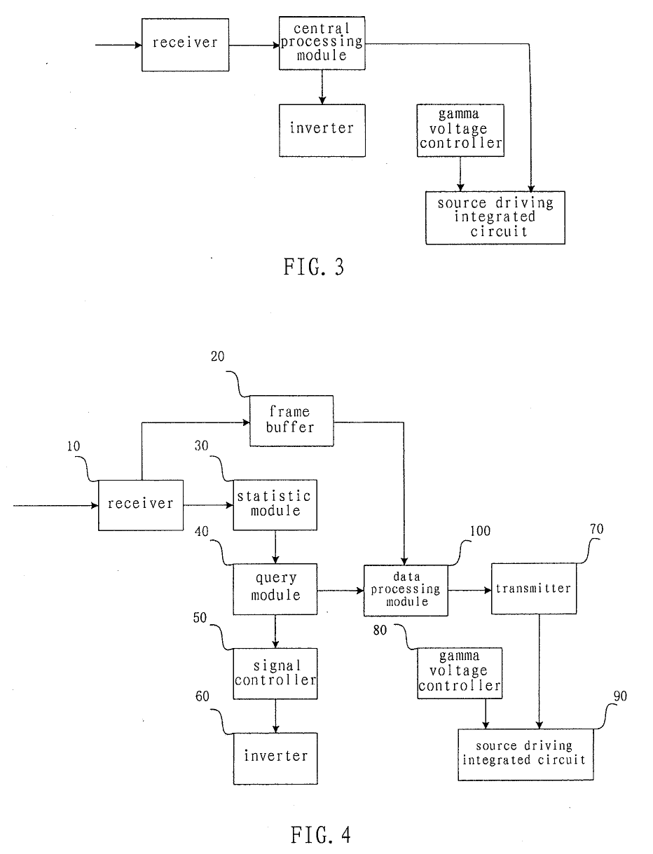

FIG. 3 is a structurally schematic diagram of a processing device for high dynamic contrast of LCD device of the invention. The processing device for high dynamic contrast of LCD device comprises: a receiver, an inverter and a source driving IC connected to a central processing module, respectively; and a gamma voltage controller connecting to the source driving IC. The receiver receives a low voltage differential signaling data. The central processing module performs histogram statistic processing on the received data, obtains a backlight source dimming coefficient of picture of a same frame and an I/O gray scale mapping table according to result of the statistic processing, generates a pulse-width modulation (PWM) dimming control signal, and the output data obtained from the I/O gray scale mapping table. The inverter and the source driving IC function as an execution mechanism. The inverter receives the PWM dimming control signal from the central processing module and drives the backlight source, controls the luminance thereof. The source driving IC receives the output data obtained according to the I/O gray scale mapping table from the central processing module and the gamma reference voltage output from the gamma voltage controller, and keeps the luminance of the liquid crystal panel unchanged after the luminance of the backlight source varies by changing the transmittance of the pixel point on the liquid crystal panel. The above solution of the present invention decreases the luminance of the backlight source to lower that of the picture while compensating the distortion due to the decrease in the luminance of the backlight source by adjusting the transmittance of the panel. In particular, the present invention performs histogram statistic processing on input low voltage differential signaling data, adjusts the luminance of the backlight source and the data input to the liquid crystal panel, respectively, according to the result of the histogram statistic processing, therefore improves the dynamic contrast of pictures, and mitigates the problems of relatively low contrast in the TFT LCD devices. This solution mitigates the problems about flicker by maintaining the luminance of the liquid crystal panel unchanged after the luminance of the backlight source varies. Meantime, since the luminance of the backlight source is adjusted in a manner of the external PWM dimming, power consumption of the backlight source is saved.

FIG. 4 is a structurally schematic diagram of an embodiment of the invention. This embodiment comprises a receiver 10, a statistic module 30, a query module 40, a signal controller 50 and an inverter 60 sequentially connected in series, and further comprises a frame buffer 20, a transmitter 70, a gamma voltage controller 80, a source driving IC 90 and a data processing module 100. The input of the frame buffer 20 is connected to the receiver 10. The output of the frame buffer 20 is connected to the data processing module 100. The data processing module 100 is connected to the output of the query module 40 and the input of the transmitter 70. The output of the transmitter 70 and the output of the gamma voltage controller 80 are connected to the source driving IC 90. The receiver 10 receives an input low voltage differential signaling data and converts the received low voltage differential signaling data into data in a Transistor-Transistor Logic (TTL) format. The statistic module 30 receives the format-converted data from the receiver 10, converts the data into gray scale, and then performs the histogram statistic processing on the gray scale. The query module 40 receives the result of the histogram statistic processing from the statistic module 30 and obtains a backlight dimming coefficient and an I/O gray scale mapping table of picture of a same frame according to the result of the statistic processing. The signal controller 50 receives the backlight dimming coefficient from the query module 40 and generates a PWM dimming control signal. The inverter 60 receives the PWM dimming control signal from the signal controller 50 and drives the backlight source according to the PWM dimming control signal to vary the luminance of the backlight source. At the same time, the frame buffer 20 receives the input data in TTL format from the receiver 10 and input the data to the data processing module 100. The data processing module 100 reads the I/O gray scale mapping table from the query module 40, converts the data input from the frame buffer 20 into gray scale, and then maps it into an output gray scale according to the I/O gray scale mapping table, and then converts the output gray scale into an output data in TTL format. The transmitter 70 receives the output data from the data processing module 100 and transmits it to the source driving IC 90. The transmittance of each pixel point of the liquid crystal panel is changed according to the processed data, so that the luminance of the pixel points whose gray scales are dominantly distributed on the liquid crystal panel is kept unchanged after the luminance of the backlight source varies.

The receiver 10 receives the input low voltage differential signaling data and converts it into the data in TTL format to facilitate the data statistics by the statistic module 30.

The histogram statistics is to perform statistics on the luminance of each point on picture of a frame in a manner of gray scale, and distribution of each gray scale can be obtained from the result of statistics. For example, when resolution of a display is XGA (1024×768), that is, a picture of an entire frame has 1024×768=786432 pixel points each of which is composed of three sub-pixels of red (R), green (G) and blue (B). The histogram statistic module 30 combines the R, G, B data in TTL format that are input by the receiver 10 into a gray scale corresponding to the pixel point according to the following gray scale combination equation (2), which is shown as

Y=0.299R+0.587G+0.114B (2)

Thus the statistics may be performed on all the pixel points by using the gray scales as a standard, the result of the statistics is the number of pixel points occupied by each gray scale in picture of this frame. The histogram statistics performed by the statistic module 30 of the embodiment on the input data comprises that: a threshold value is set on the histogram; if a statistical number of a certain gray scale is over this threshold value, then this gray scale has a more distribution in picture of this frame and the processing performed on its details should be enhanced, or at least, its details should be ensured to be not lost; likewise, if a statistical number of a certain gray scale is below this threshold value, then this gray scale has a less distribution in picture of the frame and the processing performed on its details should be weakened.

The query module 40 determines the dimming coefficient β of the backlight source based on the statistical result of the statistic module 30. For example, if in the statistical result, the number of high gray scale is less, that is, the whole picture of the frame is relative dark picture, then the dimming coefficient β may be reduced, the standard of which is to ensure that at least the details of middle and low gray scales with more distributions will not be lost.

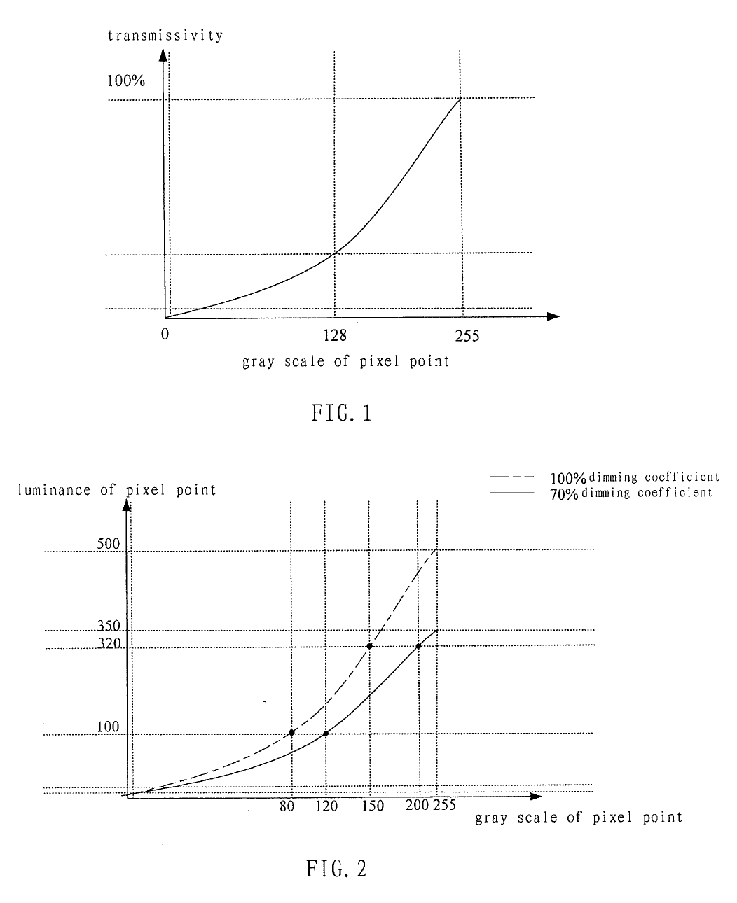

FIG. 1 is a gamma curve of a liquid crystal panel. When a gamma reference voltage of the LCD device is certain, the gamma curve is uniquely determined, that is, the correspondence between the transmittance and the gray scale of the pixel point is uniquely determined. The transmittance of each pixel point on the liquid crystal panel may be changed by changing the gray scale.

According to the above equation (1) of pixel point luminance on the liquid crystal panel, a relationship between the luminance L and the gray scale d of the liquid crystal panel may be obtained, which is referred to as L-D curve, as shown in FIG. 2. FIG. 2 is a graph of an L-D curve of the luminance and the gray scale of a pixel point on the liquid crystal panel. The luminance B of the backlight source is proportional to the dimming coefficient β. When the dimming coefficient β=100%, the luminance of the backlight source is the highest. The luminance of the backlight source will reduce as the dimming coefficient β decreases. Thus, different L-D curves may be plotted with different dimming coefficients β according to the equation (1) (as shown in FIG. 2). When the dimming coefficient β=100%, the greatest luminance of the liquid crystal panel is 500 nit, and when β=70%, the greatest luminance of the liquid crystal panel is 350 nit. For a point with the luminance of the liquid crystal panel being 320 nit, corresponding points may be found in two curves of β=100% and β=70% with the different corresponding gray scales. For different dimming coefficients β₁ and β₂, if the luminance of this pixel point on the liquid crystal panel is required to be identical, only proper gray scales should be given, that is

B(β₁)×T(d₁)=B(β₂)×T(d₂) (3)

where d₁ represents the corresponding gray scale under the dimming coefficient β₁; T(d₁) is the transmittance of this pixel point on the liquid crystal panel corresponding to the gray scale d₁; d₂ represents the corresponding gray scale under the dimming coefficient β₂, and T(d₂) is the transmittance of this pixel point on the liquid crystal panel corresponding to the gray scale d₂. Thus, the dimming coefficient β may be decreased in a certain range. By adjusting the transmittance T of the pixel point on the liquid crystal panel, thus the final luminance output from this pixel point on the liquid crystal panel is kept unchanged.

The setting up of the correspondence between the backlight source dimming coefficient and the gray level comprises: adjusting the equation as B(β₁)×T(d₁)=B(β₂)×T(d₂), where d₁ represents the corresponding gray scale under the dimming coefficient β₁, and d₂ is the corresponding gray scale under the dimming coefficient β₂. Assuming the dimming coefficient β₁ is always equal to the maximum of the backlight dimming coefficient₁ (β₁=100%). When the histogram statistics on picture of a frame is completed, the dimming coefficient β₂ can be obtained from the result of the histogram statistics. In the case that β₁ and β₂ are determined, an output gray scale d₂ can be calculated from the equation (3) given an arbitrary input gray scale d₁. All the output gray scales corresponding to the condition of the dimming coefficient β₂ can be calculated according to the input gray scales and the equation (3). Thus, mapping relation between all of the input gray scales and the output gray scales under the condition of the dimming coefficient β₂ can be obtained. With the same procedure, mapping relations between all of the input gray scales and output gray scales with different dimming coefficients can be obtained, and the mapping relations between the input gray scales and output gray scales are stored in a lookup table as a form of table. In operation of the system, when it is detected that a certain dimming coefficient is output, the I/O gray scale mapping table corresponding to this dimming coefficient is read from the lookup table and the process of lookup is completed.

From the above analysis, the query module 40 of the present embodiment is actually a table structure which reflects the correspondence between the backlight source luminance and the I/O gray scale mapping table. Specifically, body structure of the query module 40 is a storage unit with the lookup table stored therein and cooperating with a corresponding addresser. The statistic module 30 performs the histogram statistic processing on the input data and then obtains a gray scale distribution result of picture of a frame. The query module 40 queries the relation table between the backlight source dimming coefficient and the I/O gray scale mapping table stored in the lookup table according to the obtained result of the histogram statistic processing.

The data processing module 100 converts the data in TTL format input by the frame buffer 20 into a gray scale (i.e. the input gray scale) according to the equation (2), and then maps the input gray scale into an output gray scale according to the I/O gray scale mapping table read from the query module 40. Then the data processing module 100 restores linearly the output gray scale into an output data in TTL format according to the input gray scale and the equation (2). The transmitter 70 reads the output data from the query module and input it to the source driving IC 90.

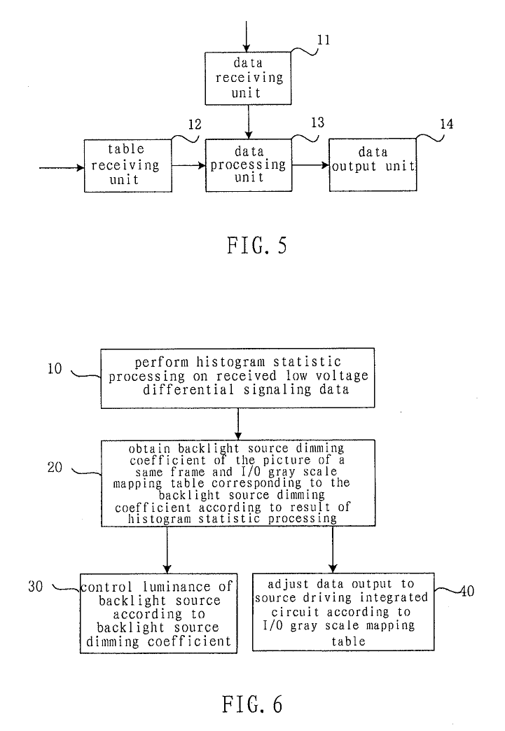

FIG. 5 shows a structurally schematic diagram of a data processing module of an embodiment of the present invention. The data processing module 100 comprises a data receiving unit 11, a table receiving unit 12, a data receiving unit 13, a data output unit 14. The data receiving unit 11 transmits the data in TTL format received from the frame buffer 20 to the data processing unit 13. The table receiving unit 12 transmits the I/O gray scale mapping table received from the query module 40 to the data processing unit 13. The data processing unit 13 converts the received data in TTL format into a gray scale (i.e. the input gray scale) according to the equation (2), and maps the input gray scale into the output gray scale according to the I/O gray scale mapping table. The data output unit 14 receives the output gray scale of the data processing unit 13 and restores linearly it into the output data in TTL format according to the input gray scale and the equation (2).

The query module 40 inputs the dimming coefficient to the signal controller 50 which in the above embodiment of this invention is actually a PWM dimming signal controller and controls the luminance of the backlight source by adjusting the duty cycle of the output PWM dimming control signal, wherein the duty cycle of the PWM dimming control signal is the dimming coefficient β of the backlight source. The luminance of the cold cathode fluorescent lamp (CCFL) backlight source depends directly on the lamp current in the CCFL lamp. The driving of the lamp current is performed by a DC to AC inverter. Digital mode for luminance adjusting by the inverter is also referred to as pulse width modulation (PWM) mode. The luminance of the backlight source is controlled by adjusting the duty cycle of a PWM dimming signal. The duty cycle of the PWM dimming signal is larger, the time period in which the backlight source is in ON state within a dimming cycle is longer, and therefore the luminance of the backlight source is higher. Since the backlight source is continuously in an alternative state of ON and OFF under this adjusting manner, a PWM Dimming signal with higher frequency than that of a refresh rate (typically between 120 Hz-240 Hz) is used to control the ON and OFF of the backlight source, and thus the human eyes will not perceives the flicker of the backlight source.

In the embodiment of the present invention, the signal controller 50 inputs the PWM dimming signal to the inverter 60 and controls the luminance of the backlight source by adjusting the duty cycle of the PWM dimming signal.

In the work process of the processing device for high dynamic contrast of the LCD device of the present invention, firstly, the receiver 10 receives the input low voltage differential signaling data and converts the format of the low voltage differential signaling data format into TTL signal format, and then the statistic module 30 performs the histogram statistic processing. At the same time, the frame buffer 20 receives the data in TTL format from the receiver 10 and inputs the data to the data processing module 100. The query module 40 obtains the backlight source dimming coefficient according to the result of the statistic processing by the statistic module 30 and finds the I/O gray scale mapping table corresponding to the dimming coefficient through the lookup table. The data processing module 100 maps the data input by the frame buffer 20 into the output data according to the I/O gray scale mapping table input by the query module 40. The transmitter 70 reads the output data from the data processing module 100 and inputs it to the source driving IC 90. The signal controller 50 generates the PWM dimming control signal according to the dimming coefficient output by the query module 40 and transmits the control signal to the inverter 60 driving the backlight source. The source driving IC 90 drives the liquid crystal panel by receiving the gamma reference voltage of the gamma voltage controller 80 and the data output by the transmitter 70.

Therefore, since the backlight source is controlled continuously by the PWM dimming signal output from the signal controller 50 and is in a successively alternative state between ON and OFF, a part of power is saved. Especially in the case where the displayed picture is mostly in the dark state, more power can be saved. The power consumption of the backlight source is over 40% of that in the entire LCD. Such adjusting solution for backlight source luminance of the present invention saves the power consumption of the backlight source and reduces that of the final product.

FIG. 6 is a flow chart of a processing method for high dynamic contrast of LCD device of an embodiment of the invention, which includes in particular:

step 10 of performing histogram statistic processing on a received low voltage differential signaling data;

step 20 of obtaining a backlight source dimming coefficient of picture of a same frame and an I/O gray scale mapping table corresponding to the backlight source dimming coefficient according to result of the histogram statistic processing;

step 30 of controlling to adjust data output to a source driving integrated circuit (IC) according to the I/O gray scale mapping table; and

step 40 of controlling luminance of a backlight source according to the backlight source dimming coefficient.

The above solution of the present invention decreases the luminance of the backlight source to lower that of the picture while compensating the distortion due to the decrease in the luminance of the backlight source by adjusting the transmittance. In particular, the present invention adjusts the luminance of the backlight source and the data output to the source driving IC, respectively, according to the result of the histogram statistic processing, therefore improves the dynamic contrast of pictures and mitigates the problems of relatively low contrast in the TFT LCD devices. This solution mitigates the problems about flicker by making the luminance of the liquid crystal panel unchanged after the luminance of the backlight source varies through the luminance query mode. Also, since the luminance of the backlight source is controlled by the external PWM dimming signal, power consumption of the backlight source is saved.

The step 10 includes in particular

step 11 of obtaining number of pixel points occupied by each gray scale on picture of a frame; and

step 12 of determining the gray scales that have more distribution in picture of the frame according to a threshold value.

The present invention firstly performs statistics on all the pixel points using the histogram statistics based on the gray scales, obtains the number of pixel points occupied by each gray scale in picture of the frame, and obtains the distribution condition of each gray scale in picture of the frame by comparison with the threshold value.

The step 20 includes in particular calculating the I/O gray scale mapping relation corresponding to the dimming coefficient according to the relation between the luminance of the pixel point on the liquid crystal panel, and the gray scale and the dimming coefficient, and storing in the query module the I/O gray scale mapping relation in the form of the I/O gray scale mapping table.

Once the dimming coefficient is determined, the I/O gray scale mapping table corresponding to the dimming coefficient is read out from the lookup table and the process of lookup is completed.

The step 30 includes in particular

step 31 of converting the received input data in TTL format into an input gray scale;

step 32 of mapping the input gray scale into an output gray scale according to the I/O gray scale mapping table;

step 33 of converting the output gray scale into an output data in TTL format and transmitting the output data to a transmitter; and

step 34, that the transmitter reading the output data from a data processing module and sending the output data to the source driving IC.

The step 40 includes in particular

step 41 of generating a pulse-width modulation (PWM) dimming control signal according to the backlight source dimming coefficient; and

step 42 of using the PWM dimming control signal to drive the backlight source.

After the PWM dimming control signal is generated based on the backlight source dimming coefficient, the backlight source is driven to change its luminance.

The above solution of the present invention improves significantly the dynamic contrast and quality of a picture in the premise of constant luminance of the liquid crystal panel by decreasing the luminance of the backlight source to lower that of the picture while compensating the distortion due to the decrease in the luminance of the backlight source by the transmittance. In particular, the present invention performs histogram statistic processing on input data, adjusts the luminance of the backlight source and the output data of the liquid crystal panel concurrently, according to the result of the processing, therefore improves the dynamic contrast of pictures and mitigates the problems of relatively low contrast in the TFT display apparatus. The solution of the processing method for high dynamic contrast of LCD device of the present invention mitigates the problems about flicker by making the luminance of the liquid crystal panel unchanged after the luminance of the backlight source varies. Also, since the luminance of the backlight source is controlled by the external PWM dimming signal, power consumption of the backlight source is saved.

At last, it should be noted that the above embodiments are only for purpose of explaining solutions of the present invention but not limiting the same. Although the present invention is described in detail with reference to the above embodiments, it should by understood by those skilled in this art that modifications or equivalent substitutions may be made to the technical solutions of the present invention without depart from the spirit and scope of the technical solutions of the present invention.

What is claimed is:

1. A processing device for high dynamic contrast of a liquid crystal display device characterized in comprising:
a receiver for receiving a low voltage differential signaling data and converting the low voltage differential signaling data into data in transistor-transistor logic format;
a central processing module connecting to the receiver for performing histogram statistic processing on the data in transistor-transistor logic format, obtaining a backlight source dimming coefficient of picture of a frame and an I/O gray scale mapping table corresponding to the dimming coefficient according to result of the statistic processing, generating a PWM dimming control signal from the backlight source dimming coefficient, and obtaining an output data according to the I/O gray scale mapping table;
an inverter for receiving the PWM dimming control signal from the central processing module and driving the backlight source;
a gamma voltage controller for providing a gamma reference voltage for a source driving IC; and
the source driving IC for receiving the output data and the gamma reference voltage from the central processing module and the gamma voltage controller, respectively, and driving a liquid crystal panel.

2. The processing device for high dynamic contrast of a liquid crystal display device of claim 1, characterized in that the central processing module comprises:
a statistic module for receiving data from the receiver and performing the histogram statistic processing on the data;
a query module for receiving result of the histogram statistic processing from the statistic module and obtaining the backlight source dimming coefficient of picture of a frame and the I/O gray scale mapping table corresponding to the dimming coefficient according to the result of the statistic processing;
a signal controller for receiving the backlight source dimming coefficient from the query module, generating the PWM control signal to be sent to the inverter;
a frame buffer for receiving the data in transistor-transistor logic format from the receiver and storing the data;
a data processing module for receiving the I/O gray scale mapping table and the data in transistor-transistor logic format from the query module and the frame buffer, respectively, and mapping the data in transistor-transistor logic format into the output data according to the I/O gray scale mapping table; and
a transmitter for reading the output data from the data processing module and transmitting the output data to the source driving IC.

3. The processing device for high dynamic contrast of a liquid crystal display device of claim 2, characterized in that the query module includes a storage unit storing a lookup table which records correspondence between the backlight source dimming coefficient and the I/O gray scale mapping table.

4. The processing device for high dynamic contrast of a liquid crystal display device of claim 2, characterized in that the data processing module includes:
a data receiving unit for receiving the data in transistor-transistor logic format input from the frame buffer and converting the data in transistor-transistor logic format into a gray scale;
a table receiving unit for receiving the I/O gray scale mapping table from the query module;
a data processing unit for mapping the gray scale input by the data receiving unit into an output gray scale according to the I/O gray scale mapping table input by the table receiving unit; and
a data output unit for converting the output gray scale received from the data processing unit into the output data in the transistor-transistor logic format and outputting the data.

5. A processing method for high dynamic contrast of a liquid crystal display device, characterized in comprising:
performing histogram statistic processing on a received low voltage differential signaling data;
obtaining a backlight source dimming coefficient of picture of a same frame and an I/O gray scale mapping table corresponding to the backlight source dimming coefficient according to result of the histogram statistic processing;
controlling to adjust data output to a source driving IC according to the I/O gray scale mapping table; and
controlling luminance of a backlight source according to the backlight source dimming coefficient.

6. The processing method for high dynamic contrast of a liquid crystal display device of claim 5, characterized in that said performing histogram statistic processing on a received low voltage differential signaling data comprises:
obtaining number of pixel points occupied by each gray scale on picture of a frame; and
determining the gray scales that have more distribution in picture of the frame according to a threshold value.

7. The processing method for high dynamic contrast of a liquid crystal display device of claim 5, characterized in that said obtaining a backlight source dimming coefficient of picture of a same frame and an I/O gray scale mapping table corresponding to the backlight source dimming coefficient according to result of the histogram statistic processing comprises:
determining the backlight source dimming coefficient of picture of the same frame according to the result of the histogram statistic processing, and then calculating an I/O gray scale mapping relation corresponding to different dimming coefficients according to a relation between luminance of pixel points on a liquid crystal panel, and the gray scale, the dimming coefficient; and
storing in a query module the I/O gray scale mapping relation in a form of the I/O gray scale mapping table.

8. The processing method for high dynamic contrast of a liquid crystal display device of claim 5, characterized in that said controlling to adjust data output to a source driving IC according to the I/O gray scale mapping table comprises:
converting the received input data in the transistor-transistor logic format into an input gray scale;
mapping the input gray scale into an output gray scale according to the I/O gray scale mapping table;
converting the output gray scale into an output data in the transistor-transistor logic format and transmitting the output data to a transmitter; and
the transmitter reading the output data from a data processing module and sending the output data to the source driving IC.

9. The processing method for high dynamic contrast of a liquid crystal display device of claim 5, characterized in that said controlling luminance of a backlight source according to the backlight source dimming coefficient comprises:
generating a PWM dimming control signal according to the backlight source dimming coefficient; and
using the PWM dimming control signal to drive the backlight source.
